(19) United States
(12) Patent Application Publication
(10) Pub. No.: US 2026/0148258 A1
(43) Pub. Date: May 28, 2026

(54) DATA PROCESSING METHOD AND DATA PROCESSING APPARATUS

(71) Applicant: unerry, inc., Tokyo (JP)

(72) Inventors: Ruigang Zhang, Tokyo (JP); Yusuke Umeda, Tokyo (JP); Hidetoshi Uchiyama, Tokyo (JP)

(73) Assignee: unerry, inc., Tokyo (JP)

(21) Appl. No.: 19/398,428

(22) Filed: Nov. 24, 2025

(30) Foreign Application Priority Data
Nov. 26, 2024 (JP) 2024-205376

(51) Int. Cl. G06Q 30/0251

(52) U.S. Cl. CPC G06Q 30/0254

(57) ABSTRACT

Provided is a data processing method for causing a computer to execute a process. The process includes acquiring first human flow data representing a human flow in a designated area of a non-purchaser with respect to an advertisement target, and estimating a purchase possibility of an advertisement distribution target person for the advertisement target based on the first human flow data and a learned model. The learned model is generated by performing machine learning on a plurality of pieces of training data each defining a relationship between purchase data of actual purchaser with respect to the advertisement target and second human flow data representing a human flow of the actual purchaser in the designated area.

### CROSS-REFERENCE TO RELATED APPLICATION

This application is based upon and claims the benefit of priority of the prior Japanese Patent Application No. 2024-205376 filed on November 26, 2024, the entire contents of which are incorporated herein by reference.

### FIELD

A certain aspect of the embodiments is related to a data processing method and a data processing apparatus.

### BACKGROUND

Manufacturers often want to check to which customers the products manufactured by the manufacturers are sold. For example, if the fact that many products manufactured by the manufacturer are purchased by women in their 20s can be understood, the manufacturer can utilize the fact for development of new products.

Therefore, a store may collect ID-POS data in which a customer identifier (ID) for uniquely identifying a customer is associated with point of sales (POS) data indicating a sales record of a product, and provide the ID-POS data to a manufacturer. In addition, a business operator (so-called "data platformer") that operates and provides the data platform may collect ID-POS information from stores and provide the information to the manufacturer (for example, see Japanese Patent Application Publication No. 2023-107185).

Here, it is known that the ID-POS data includes, for example, a date and time when the product is purchased, a customer ID of the customer who purchases the product, a purchased product, a unit price of the product and the number of purchased products, and a total amount of the purchased product. Further, customer data including a customer ID, a gender, a postal code of a residence of the customer, and a birth month is also known (for example, see Japanese Patent Application Publication No. 2024-023848).

### SUMMARY

According to a first aspect of the present disclosure, there is provided a data processing method for causing a computer to execute a process. The process includes: acquiring first human flow data representing a human flow in a designated area of a non-purchaser with respect to an advertisement target; and estimating a purchase possibility of an advertisement distribution target person for the advertisement target based on the first human flow data and a learned model; wherein the learned model is generated by performing machine learning on a plurality of pieces of training data each defining a relationship between purchase data of an actual purchaser with respect to the advertisement target and second human flow data representing a human flow of the actual purchaser in the designated area.

In the above-mentioned configuration, each of the first human flow data, the second human flow data, and the purchase data may include a unique advertisement identifier stored in each of a plurality of mobile terminals, and the process may include identifying a part of the advertisement identifier based on a level of the purchase possibility, and using an identified part of the advertisement identifier for the first human flow data.

In the above-mentioned configuration, the purchase data may include an attribute of the actual purchaser, and the process may include estimating the purchase possibility of the advertisement distribution target person having an attribute common to the attribute of the actual purchaser.

In the above-mentioned configuration, the purchase data may include any one of a number of purchases and a purchase frequency of the actual purchaser, and the process may include estimating a purchase tendency of the advertisement distribution target person based on any one of the number of purchases and the purchase frequency.

According to a second aspect of the present disclosure, there is provided a data processing method for causing a computer to execute a process. The process includes: acquiring first human flow data representing a human flow in a designated area of a non-purchaser with respect to an advertisement target; generating visit history data of the non-purchaser with respect to a specific facility included in the designated area based on the first human flow data and time period data representing a time period during which the non-purchaser stays in the specific facility; estimating an advertisement target identifier of the advertisement target to be recommended to the non-purchaser based on the visit history data of the non-purchaser and a learned model; and estimating a purchase possibility of an advertisement distribution target person for the advertisement target based on an advertisement target tag representing a characteristic of the advertisement target identified by an advertisement target identifier of the advertisement target, and an attribute of the non-purchaser. The learned model is generated by performing machine learning on a plurality of pieces of training data each defining a relationship between tag data, and combination data of a purchaser identifier of an actual purchaser and an advertisement target identifier of the advertisement target, the tag data being obtained by combining, based on a common attribute, an advertisement target tag representing a characteristic of the advertisement target extracted based on purchase data of the actual purchaser for the advertisement target and a facility tag representing a characteristic of the specific facility extracted based on visit history data of the actual purchaser for the specific facility, the visit history data being generated based on second human flow data representing a human flow of the actual purchaser in the designated area and time period data representing a time period during which the actual purchaser stays in the specific facility.

In the above-mentioned configuration, each of the first human flow data, the second human flow data, and the purchase data may include a unique advertisement identifier stored in each of a plurality of mobile terminals, and the process may include identifying a part of the advertisement identifier based on a level of the purchase possibility, and using an identified part of the advertisement identifier for the first human flow data.

In the above-mentioned configuration, when input or selection of a confirmation item related to an advertisement of the advertisement target is detected through a predetermined screen, the process may search for an attribute of the non-purchaser corresponding to the confirmation item, and output a search result including a combination of attributes of the non-purchaser, and a purchase probability that the advertisement target is purchased by the non-purchaser to the predetermined screen or another screen different from the predetermined screen as a purchase possibility of the non-purchaser.

In the above-mentioned configuration, the process may include acquiring demographic data in the designated area, and calculating a sales quantity of the advertisement target in the designated area based on the demographic data and the purchase probability.

In the above-mentioned configuration, the process may include acquiring unit price data indicating a unit price of the advertisement object, and calculating a total purchase amount of the advertisement object by the non-purchaser in the designated area based on the sales quantity and the unit price data.

According to a third aspect of the present disclosure, there is provided a data processing apparatus including: a memory; and a processor coupled to the memory and the processor configured to: acquire first human flow data representing a human flow in a designated area of a non-purchaser with respect to an advertisement target; and estimate a purchase possibility of an advertisement distribution target person for the advertisement target based on the first human flow data and a learned model; wherein the learned model is generated by performing machine learning on a plurality of pieces of training data each defining a relationship between purchase data of an actual purchaser with respect to the advertisement target and second human flow data representing a human flow of the actual purchaser in the designated area.

According to a fourth aspect of the present disclosure, there is provided a data processing apparatus including: a memory; and a processor coupled to the memory and the processor configured to: acquire first human flow data representing a human flow in a designated area of a non-purchaser with respect to an advertisement target; generate visit history data of the non-purchaser with respect to a specific facility included in the designated area based on the first human flow data and time period data representing a time period during which the non-purchaser stays in the specific facility; estimate an advertisement target identifier of the advertisement target to be recommended to the non-purchaser based on the visit history data of the non-purchaser and a learned model; and estimate a purchase possibility of an advertisement distribution target person for the advertisement target based on an advertisement target tag representing a characteristic of the advertisement target identified by an advertisement target identifier of the advertisement target, and an attribute of the non-purchaser; wherein the learned model is generated by performing machine learning on a plurality of pieces of training data each defining a relationship between tag data, and combination data of a purchaser identifier of an actual purchaser and an advertisement target identifier of the advertisement target, the tag data being obtained by combining, based on a common attribute, an advertisement target tag representing a characteristic of the advertisement target extracted based on purchase data of the actual purchaser for the advertisement target and a facility tag representing a characteristic of the specific facility extracted based on visit history data of the actual purchaser for the specific facility, the visit history data being generated based on second human flow data representing a human flow of the actual purchaser in the designated area and time period data representing a time period during which the actual purchaser stays in the specific facility.

### BRIEF DESCRIPTION OF DRAWINGS

FIG. 1 illustrates an example of a data processing system.

FIG. 2 illustrates an example of the hardware configuration of a data processing server.

FIG. 3 illustrates an example of the functional configuration of a data processing server.

FIG. 4 illustrates an example of human flow data of actual purchasers.

FIG. 5 illustrates an example of visit history data.

FIG. 6 illustrates an example of purchaser attribute data.

FIG. 7 illustrates an example of product data.

FIG. 8 illustrates an example of ID-POS data.

FIG. 9 illustrates an example of POI data.

FIG. 10 illustrates an example of demographic data.

FIG. 11 is a flowchart illustrating an example of the operation of the data processing server.

FIG. 12 illustrates an example of giving a purchase tendency to human flow data of a non-purchaser.

FIG. 13 is a flowchart illustrating another example of the operation of the data processing server.

FIG. 14A illustrates an example of a first knowledge graph.

FIG. 14B illustrates an example of a second knowledge graph.

FIG. 14C illustrates an example of a knowledge graph aggregate.

FIG. 15 illustrates an example of a purchase potential confirmation screen.

### DESCRIPTION OF EMBODIMENTS

As described above, both the ID-POS data and the customer data include the customer ID. Therefore, when the ID-POS data and the customer data are provided from the store to the manufacturer, the manufacturer can estimate the attribute of the customer from the ID-POS data based on the customer ID common to the ID-POS data and the customer data. For example, the manufacturer can estimate the attribute of the customer such as gender and birth month from the ID-POS data. In addition, the manufacturer can estimate the age of the purchase of the product as the attribute of the customer based on the date and time when the product was purchased and the month of birth.

However, for a customer without ID-POS data, it is difficult for the manufacturer to estimate the above-described attribute of the customer. That is, since no ID-POS data is generated for a new product that is a product before it is put on the market, it is difficult for the manufacturer to estimate the purchase possibility of a non-purchaser for the new product.

In addition, even for an old product that is a product after being put on the market, since the ID-POS data is generated for each store, each store can collect the ID-POS data of only a part of actual purchaser of the old product. Therefore, it is difficult for each store or manufacturer to accurately estimate the purchase possibility of the entire old product based on only the ID-POS data.

Further, based on such a purchase possibility, an advertisement for a product is often distributed to an advertisement distribution target person. Therefore, when the purchase possibility cannot be estimated, there is a possibility that an appropriate advertisement for the product is not distributed to the advertisement distribution target person. Such a possibility is not limited to the product, and the same applies to the service.

Therefore, according to an aspect, it is desirable to provide a data processing method and a data processing device that estimate a purchase possibility of an advertisement distribution target person for an advertisement target such as a product or a service.

Hereinafter, embodiments of the present disclosure will be described with reference to the drawings. In the embodiment described later, a product is described as an example of an advertisement target, but the advertisement target is not limited to a product, and may be a service such as a restaurant.

### First Embodiment

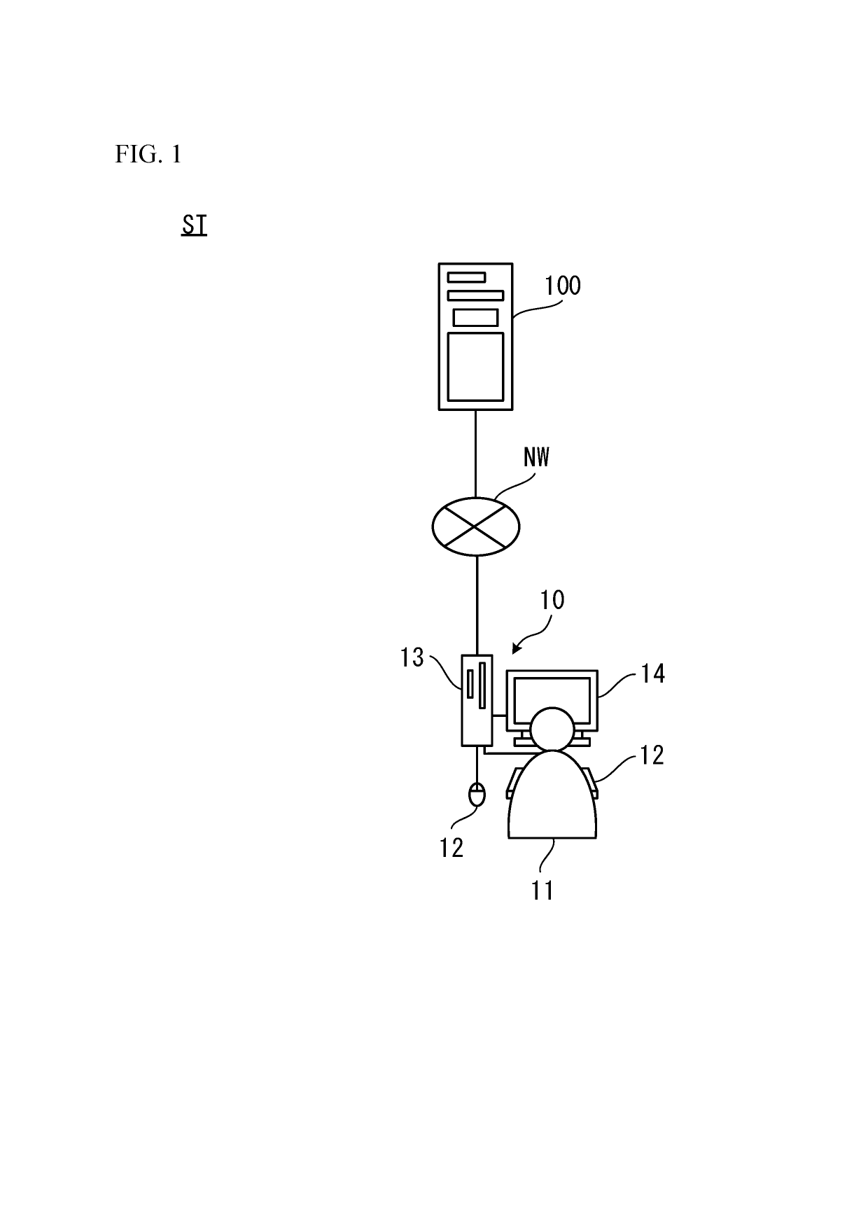

As illustrated in FIG. 1, a data processing system ST is a computer system including a terminal device 10 and a data processing server 100. The terminal device 10 and the data processing server 100 are connected to each other via a communication network NW. The communication network NW includes one or both of a local area network (LAN) and the Internet.

In FIG. 1, a personal computer (PC) is illustrated as an example of the terminal device 10, but the terminal device 10 is not limited to the PC. The terminal device 10 may be a smart terminal such as a smartphone or a tablet terminal. In addition, although a physical server device is illustrated as an example of the data processing server 100 in FIG. 1, the data processing server 100 may be a virtual server device. Further, although one data processing server 100 is illustrated as an example in FIG. 1, a plurality of data processing servers 100 may be provided in the data processing system ST, and various data processing may be distributed to the plurality of data processing servers 100.

The data processing system ST is used by a user 11 belonging to a business company. The business company may be a manufacturer that manufactures products or may be a non-manufacturer that provides services. The manufacturer includes, for example, a food manufacturer, a cosmetic manufacturer, and a shoe manufacturer, but is not particularly limited to these manufacturers. The non-manufacturer includes, for example, a restaurant, a retail store, and the like, but is not particularly limited to these non-manufacturers.

The user 11 can use the data processing system ST by operating an input device 12 included in the terminal device 10 and accessing the data processing server 100. For example, when the user 11 performs a predetermined operation on the input device 12, a control device 13 of the terminal device 10 transmits an instruction corresponding to the predetermined operation to the data processing server 100. When the data processing server 100 receives the instruction, the data processing server 100 executes various data processing based on the received instruction and transmits a processing result to the control device 13.

Although details will be described later, for example, when the data processing server 100 receives the instruction corresponding to the predetermined operation, the data processing server 100 estimates a purchase possibility of the non-purchaser who has not purchased a new product which is a product before being put on the market, and transmits the estimated purchase possibility to the control device 13 as the processing result. When the control device 13 receives the processing result, the control device 13 displays a predetermined screen including the processing result on a display device 14 included in the terminal device 10. As a result, the predetermined screen appears on the display device 14. The user 11 can understand the purchase possibility of the non-purchaser who has not purchased the new product by browsing the predetermined screen.

In this way, since the purchase possibility of the non-purchaser can be estimated, the data processing server 100 can distribute an appropriate advertisement for the new product to the advertisement distribution target person. Even for an old product that is a product after being put on the market, the data processing server 100 can accurately estimate the purchase possibility of the entire old product for each store or manufacturer based on only the ID-POS data. Therefore, it is possible to distribute an appropriate advertisement for the old product to the advertisement distribution target person.

The purchase possibility may be, for example, the number of purchasable persons, a purchase probability, a purchase accuracy, or the like in the designated area, or may be a purchasable quantity, a purchasable amount, or the like in the designated area. The data processing server 100 may estimate a purchase tendency of the non-purchaser such as a frugal person or a spendthrift and transmit the estimated purchase tendency to the control device 13 as the processing result. In this case, the user 11 can understand the purchase tendency of the non-purchaser. In this way, the data processing server 100 may estimate the purchase possibility or the purchase tendency of the non-purchaser with respect to the new product or the old product.

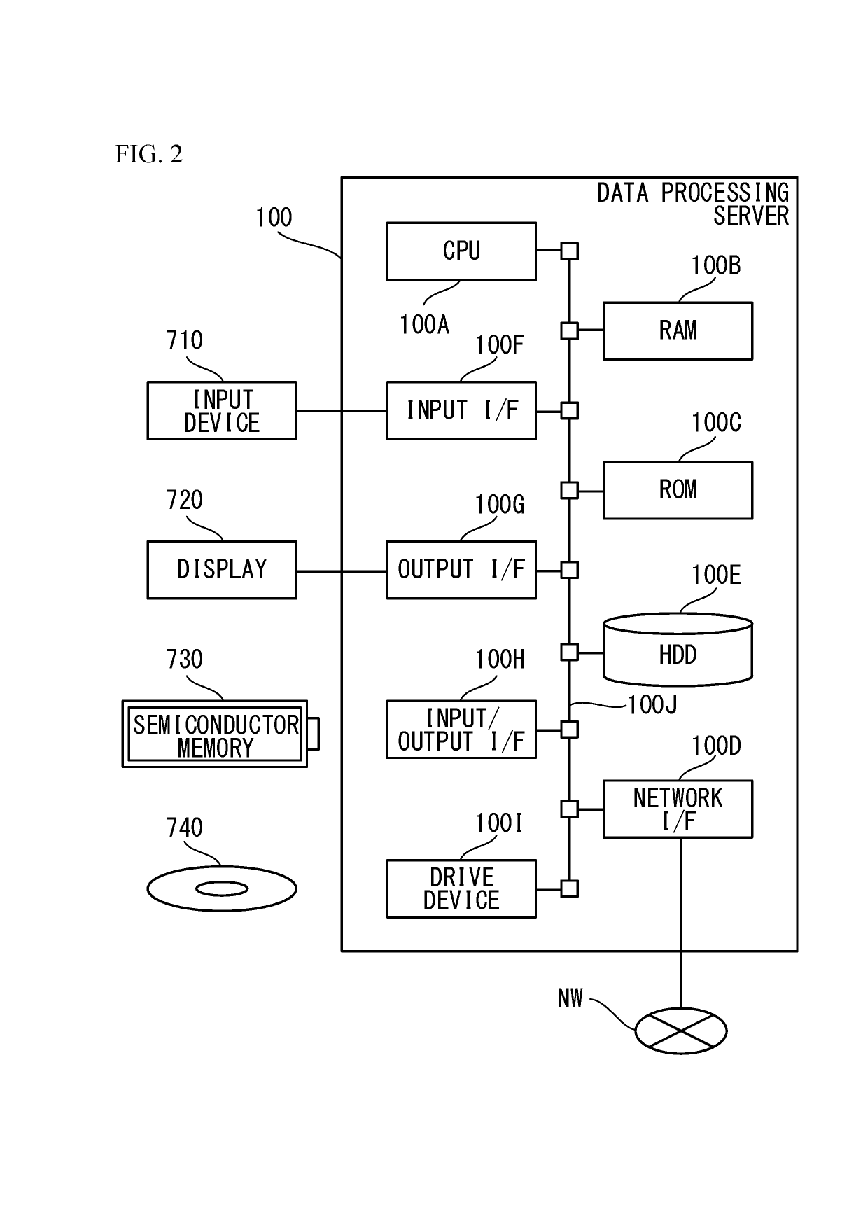

The hardware configuration of the data processing server 100 will be described with reference to FIG. 2. The terminal device 10 described above basically has the same hardware configuration as the hardware configuration of the data processing server 100, and thus detailed description thereof will be omitted.

The data processing server 100 includes a central processing unit (CPU) 100A as a processor, and a random access memory (RAM) 100B and a read only memory (ROM) 100C as memories. The data processing server 100 includes a network interface (I/F) 100D and a hard disk drive (HDD) 100E. A solid state drive (SSD) may be adopted instead of the hard disk drive (HDD) 100E.

The data processing server 100 may include at least one of an input I/F 100F, an output I/F 100G, an input/output I/F 100H, and a drive device 100I, as necessary. The components from the CPU 100A to the drive device 100I are connected to each other by an internal bus 100J. That is, the data processing server 100 can be realized by a computer.

An input device 710 is connected to the input I/F 100F. Examples of the input device 710 include a keyboard, a mouse, and a touch panel. A display device 720 is connected to the outputs I/F 100G. The display device 720 may be, for example, a liquid crystal display. A semiconductor memory 730 is connected to the input/output I/F 100H. The semiconductor memory 730 may be, for example, a universal serial bus (USB) memory or a flash memory. The input/output I/F100H reads a program stored in the semiconductor memory 730. The inputs I/F 100F and the input/output I/F 100H include, for example, USB ports. The output I/F100G includes, for example, a display port.

A portable recording medium 740 is inserted into the drive device 100I. The portable recording medium 740 may be a removable disk such as a compact disc (CD)-ROM or a digital versatile disc (DVD). The drive device 100I reads a program recorded on the portable recording medium 740. The network I/F 100D includes, for example, a LAN port, a communication circuit, and the like. The communication circuit includes one or both of a wired communication circuit and a wireless communication circuit. The network I/F 100D is connected to the communication network NW.

In the RAM 100B, the programs stored in at least one of the ROM 100C, the HDD 100E, and the semiconductor memory 730 are temporarily stored by the CPU 100A. The program recorded on the portable recording medium 740 is temporarily stored into the RAM 100B by the CPU 100A. The CPU 100A executes the stored program, so that the CPU 100A realizes various functions described later and executes a data processing method including various processes described later. The program may be a program according to a flowchart described later.

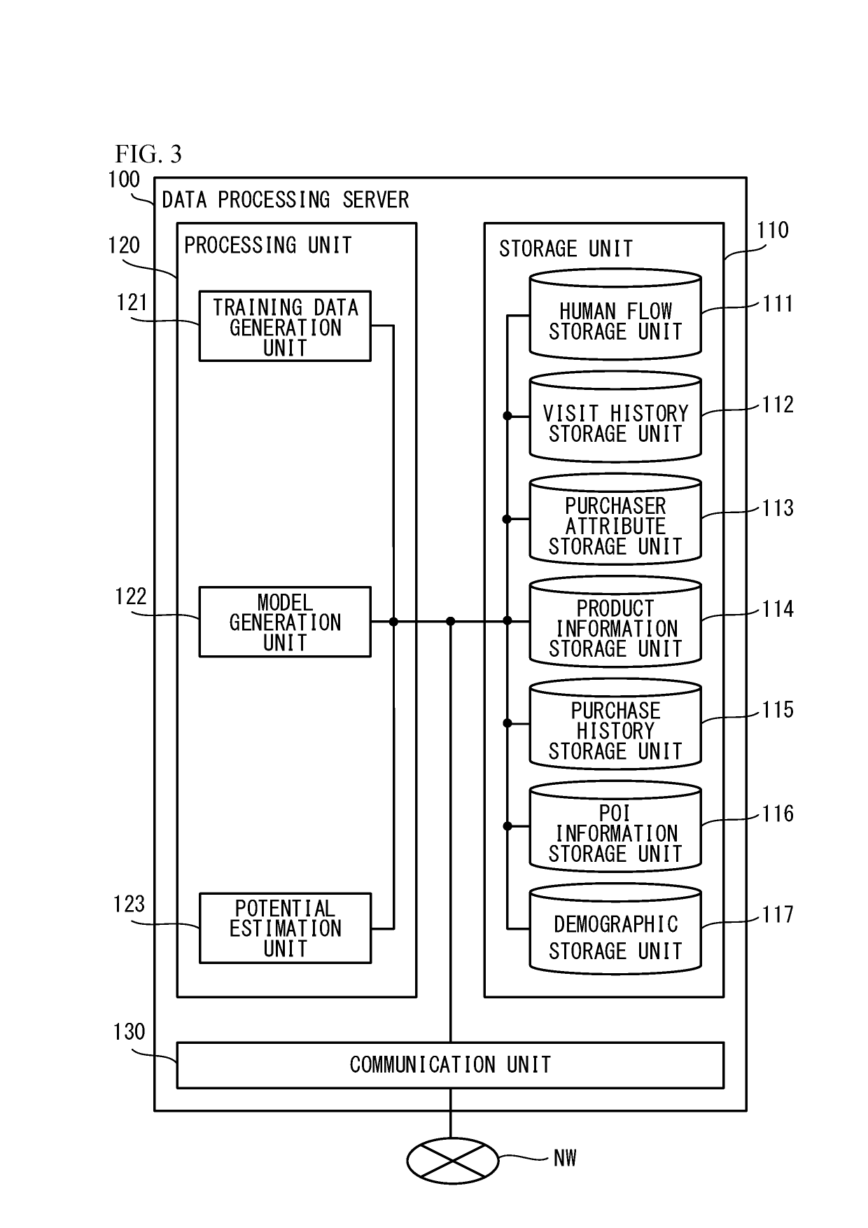

The functional configuration of the data processing server 100 will be described with reference to FIGS. 3 to 10. In FIG. 3, a main part of the function of the data processing server 100 is illustrated.

As illustrated in FIG. 3, the data processing server 100 includes a storage unit 110, a processing unit 120, and a communication unit 130. The storage unit 110 can be realized by one or both of the RAM 100B and the HDD 100E described above. The processing unit 120 can be realized by the above-described CPU 100A. The communication unit 130 can be realized by the network I/F 100D described above.

The storage unit 110, the processing unit 120, and the communication unit 130 are connected to each other. The storage unit 110 includes a human flow storage unit 111, a visit history storage unit 112, a purchaser attribute storage unit 113, and a product information storage unit 114. The storage unit 110 includes a purchase history storage unit 115, a point of interest (POI) information storage unit 116, and a demographic storage unit 117. The storage unit 110 stores various data by using the human flow storage unit 111, the visit history storage unit 112, the purchaser attribute storage unit 113, the product information storage unit 114, the purchase history storage unit 115, the POI information storage unit 116, and the demographic storage unit 117.

The processing unit 120 includes a training data generation unit 121, a model generation unit 122, and a potential estimation unit 123. The processing unit 120 processes various data by using the training data generation unit 121, the model generation unit 122, and the potential estimation unit 123.

The human flow storage unit 111 stores human flow data representing the human flow in the designated area of the actual purchaser for the old product. The old product is a product that has been on the market before the new product described above. The human flow storage unit 111 stores human flow data representing the human flow of the non-purchaser described above in the designated area. The human flow data of the non-purchaser is an example of first human flow data, and the human flow data of the actual purchaser is an example of second human flow data.

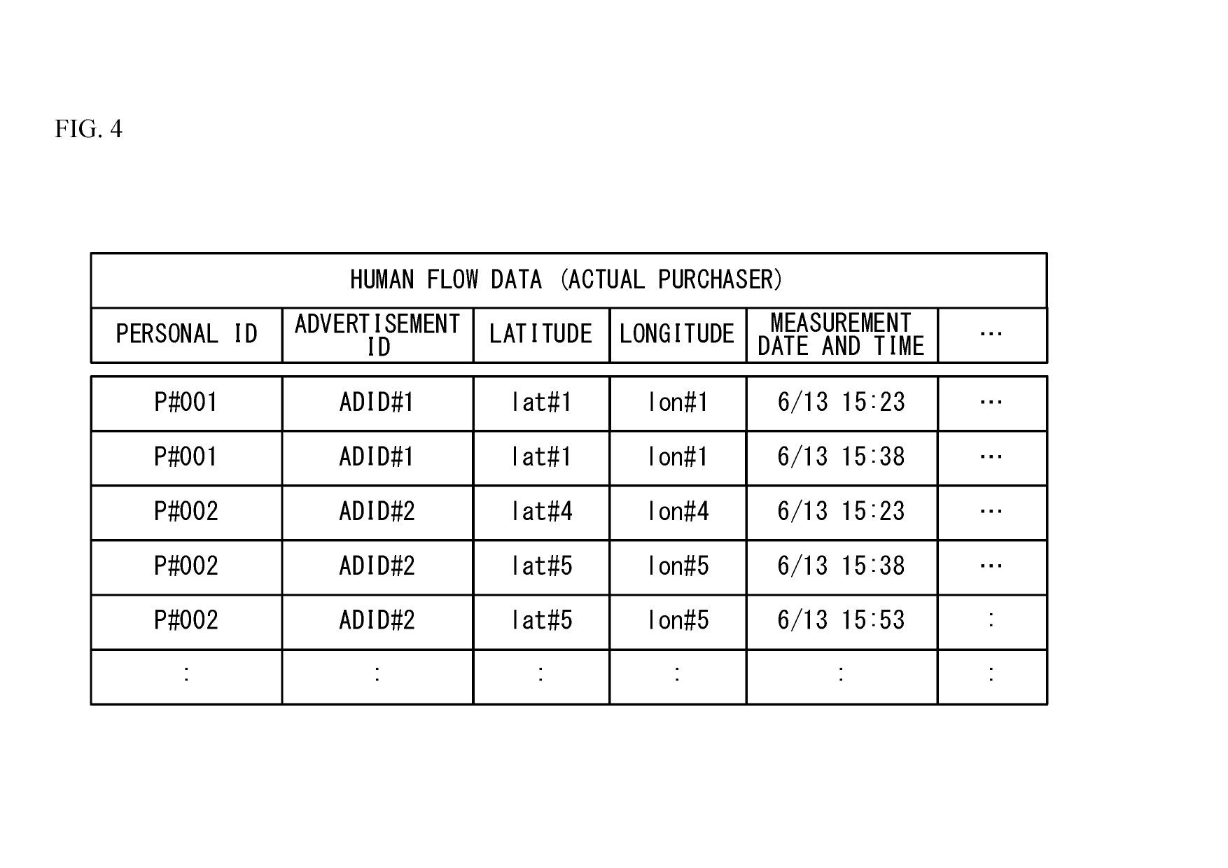

For example, as illustrated in FIG. 4, the human flow data of the actual purchaser includes a plurality of items such as a personal identifier (ID), an advertisement ID, a latitude, a longitude, and a measurement date and time. In the item of the personal ID, a unique identifier for identifying an actual purchaser individual is registered. In the item of the advertisement ID, a unique identifier that is possessed by the mobile terminal of the actual purchaser and is used only for distributing the advertisement in application software (hereinafter, simply referred to as an application) of the mobile terminal is registered. The mobile terminal may be any of a smartphone, a tablet terminal, a smartwatch, and a game terminal.

In the items of latitude, longitude, and measurement date and time, for example, the latitude and longitude of the mobile terminal measured by a global positioning system (GPS) function of the mobile terminal are registered together with the measurement date and time. The latitude and longitude of the mobile terminal estimated based on the radio wave intensity of a Bluetooth beacon wirelessly communicated between the mobile terminal possessed by the actual purchaser and a beacon terminal installed in various facilities described later and the installation position of the beacon terminal may be registered. In this manner, the latitude and longitude for specifying the position of the portable terminal are periodically measured by the GPS function or the like. Therefore, when the actual purchaser moves while carrying the portable terminal, the moving situation of the actual purchaser is expressed as the human flow. The human flow data of the non-purchaser is basically the same as the human flow data of the actual purchaser, and thus detailed description thereof will be omitted.

Returning to FIG. 3, the visit history storage unit 112 stores visit history data representing a history of the actual purchaser visiting the POI. The POI is an example of a specific facility, and includes, for example, a commercial facility such as a store including a restaurant and a retail store. The POI may include public facilities such as parks, libraries, and stations, competition facilities such as ballparks and soccer stadiums, medical facilities such as hospitals and clinics, roads such as sidewalks and driveways, and the like. The road may be a road dedicated to automobiles (for example, a national highway for automobiles, an urban highway, or the like) including a service area (SA), a parking area (PA), or the like, or may be a general road other than the road dedicated to automobiles including an intersection, a T-junction, or the like. Note that the POI is not limited to such an artificial object, and may include a natural object such as a mountain, a river, or a lake. In this way, the POI corresponds to a specific feature on the map information, such as an artificial object or a natural object.

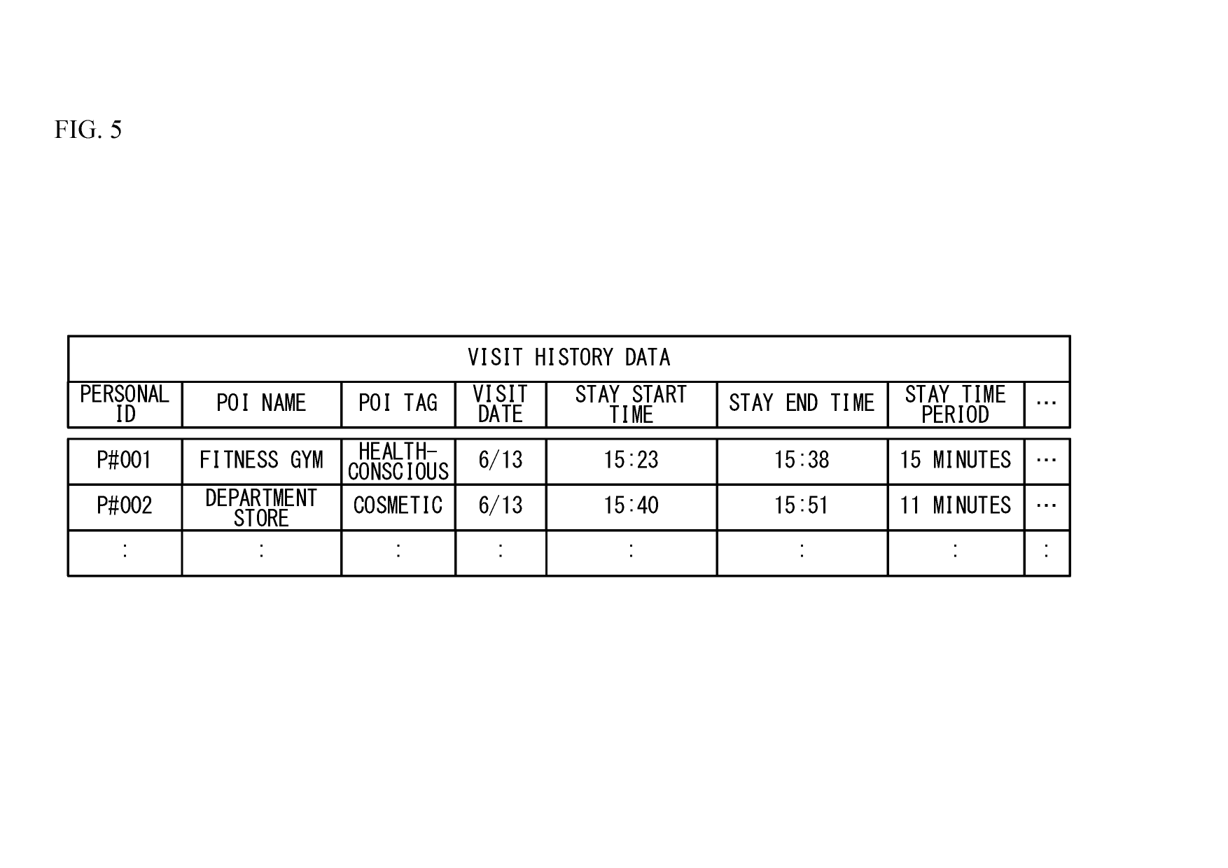

As illustrated in FIG. 5, the visit history data includes a plurality of items such as a personal ID, a POI name, a POI tag, a visit date, a stay start time, a stay end time, and a stay time period. In the item of the personal ID, a unique identifier for identifying the actual purchaser individual or the non-purchaser is registered. In the item of the POI name, the name of the POI visited by the actual purchaser or the non-purchaser is registered. In the item of the POI tag, a characteristic of the POI associated with the POI is registered as the POI tag. For example, when word-of-mouth information is posted for the POI on the Internet, some words included in the word-of-mouth information are registered as the POI tag. In the item of the visit date, a date on which the actual purchaser or the non-purchaser visits the POI is registered.

In the items of the stay start time, the stay end time, and the stay time period, a time at which the user starts staying at the POI, a time at which the user ends staying at the POI, and a time period during which the user stays at the POI are registered. When the actual purchaser and the non-purchaser stay at a specific position for a certain time period, it is estimated that the actual purchaser and the non-purchaser stay at the POI provided at the specific position for a certain time period. The visit history data is generated based on the human flow data of the actual purchaser and the non-purchaser and the POI data described later, and is stored in the visit history storage unit 112.

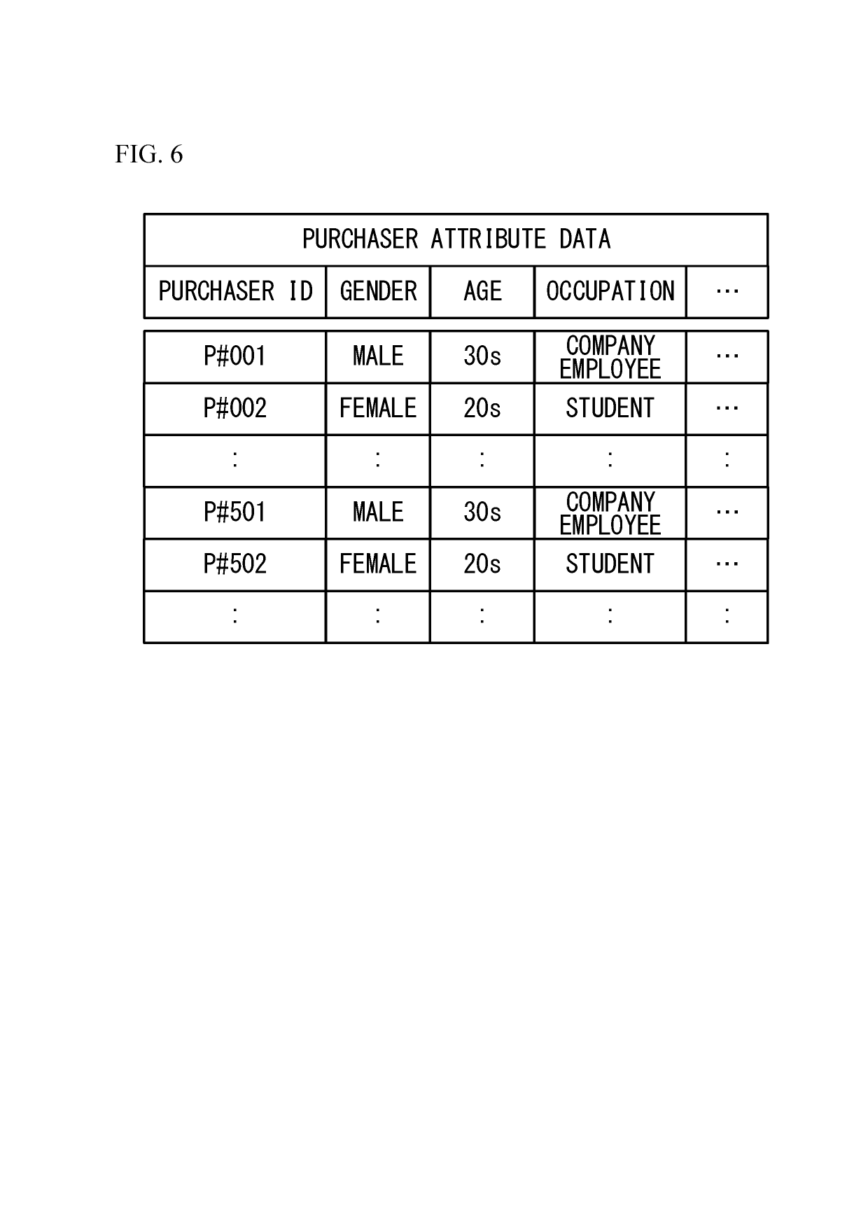

Returning to FIG. 3, the purchaser attribute storage unit 113 stores purchaser attribute data representing the attribute of the actual purchaser. As illustrated in FIG. 6, the purchaser attribute data includes a plurality of items such as a purchaser ID, a gender, an age, and an occupation. The items of the purchaser attribute data may include a zip code, a birth date, a nationality, and the like of a residential area. In the item of the purchaser ID, a unique identifier for identifying the actual purchaser or the non-purchaser is registered. In the item of the gender, a gender of the actual purchaser or the non-purchaser is registered. In the item of the age, an age based on the birth date of the actual purchaser or the non-purchaser is registered. In the item of the occupation, an occupation of the actual purchaser and the non-purchaser is registered. The purchaser attribute data is generated based on, for example, information entered when a membership card usable in the store is issued or information input to the member application, and is stored in the purchaser attribute storage unit 113.

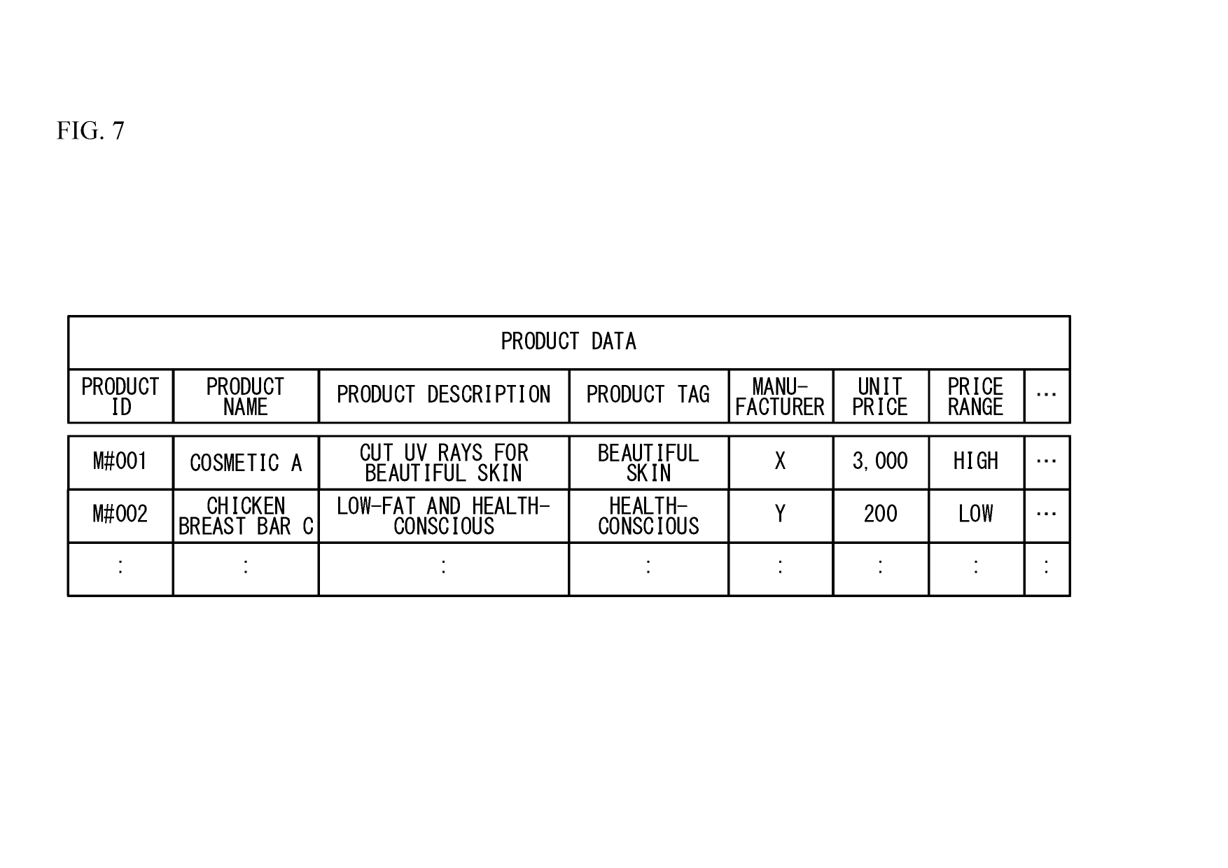

Returning to FIG. 3, the product information storage unit 114 stores product data relating to the new product and the old product. As illustrated in FIG. 7, the product data includes a plurality of items such as a product ID, a product name, a product description, a product tag, a manufacturer, a unit price, and a price range. In the item of the product ID, a unique identifier for identifying the new product or the old product is registered. As an identifier registered in the item of the product ID, for example, a JAN (Japanese Article Number) code may be used. In the item of the product name, a name of the new product or the old product is registered. In the item of the product description, a sentence describing the characteristic of the new product or the old product is registered.

In the item of the product tag, a part of words included in the sentence registered in the product description is registered as the product characteristic. The number of product characteristics registered in the item of the product tag may be one or more. In the item of the manufacturer, a name of the manufacturer that manufactures the new product or the old product is registered. In the item of the unit price, a unit price of the new product or the old product is registered. In the item of the price range, a price range of the new product or the old product, such as a high price range or a low price range, is registered.

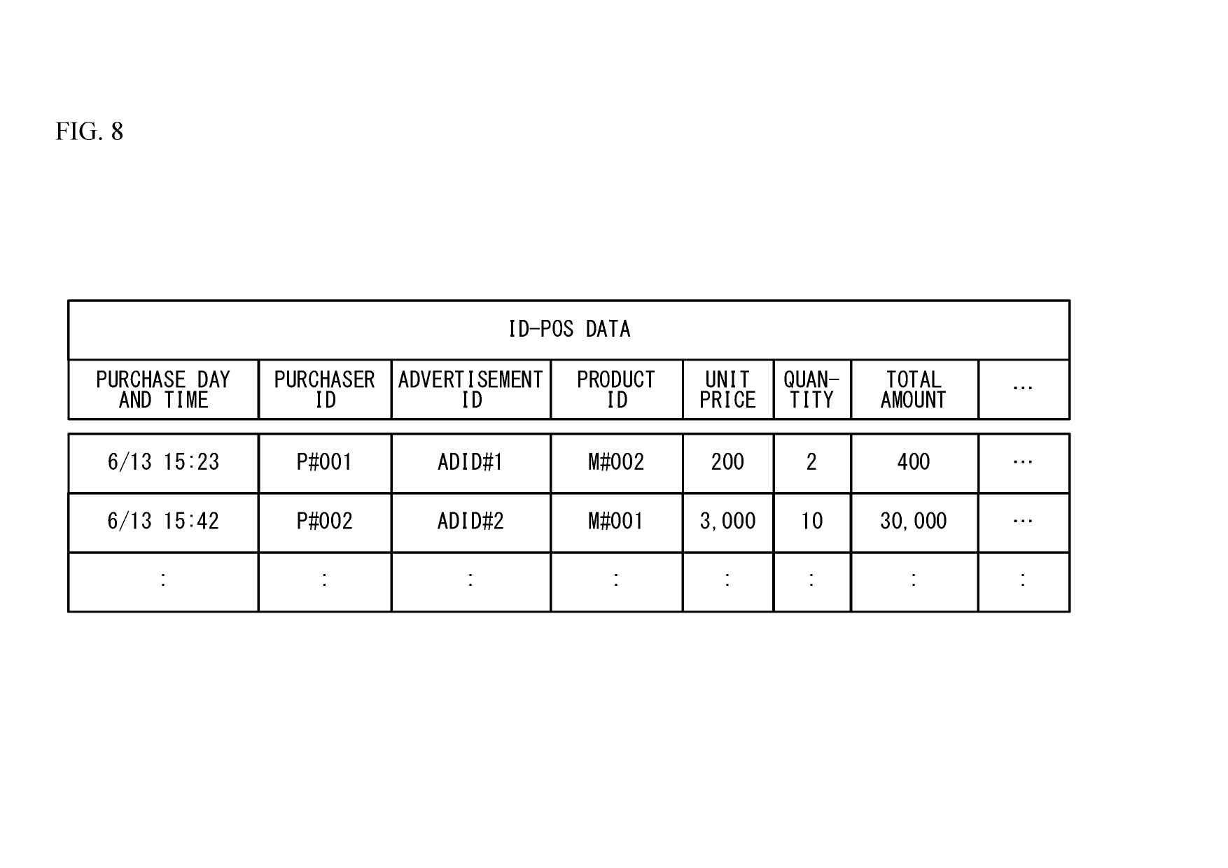

Referring back to FIG. 3, the purchase history storage unit 115 stores the ID-POS data in which the purchaser ID and POS data indicating a sales record of the old product are associated with each other. The ID-POS data is an example of the purchase data of the actual purchaser. As illustrated in FIG. 8, the ID-POS data includes a plurality of items such as a purchase date and time, a purchaser ID, an advertisement ID, a product ID, a unit price, a quantity, and a total amount. In the item of the purchase date and time, a date and time when the actual purchaser identified by the purchaser ID purchases the old product is registered.

In the item of the purchaser ID, a unique identifier for identifying the actual purchaser is registered. In the item of the advertisement ID, a unique identifier that is possessed by the mobile terminal of the actual purchaser and is used only for distributing the advertisement in the application of the mobile terminal is registered. In the item of the product ID, a unique identifier for identifying the old product is registered. In the item of the unit price, a unit price of the old product is registered. In the item of the quantity, a quantity of old product purchased by the actual purchaser is registered. In the item of the total amount, a multiplication result of the unit price of the old product registered in the item of the unit price and the quantity of old products registered in the item of the quantity is registered.

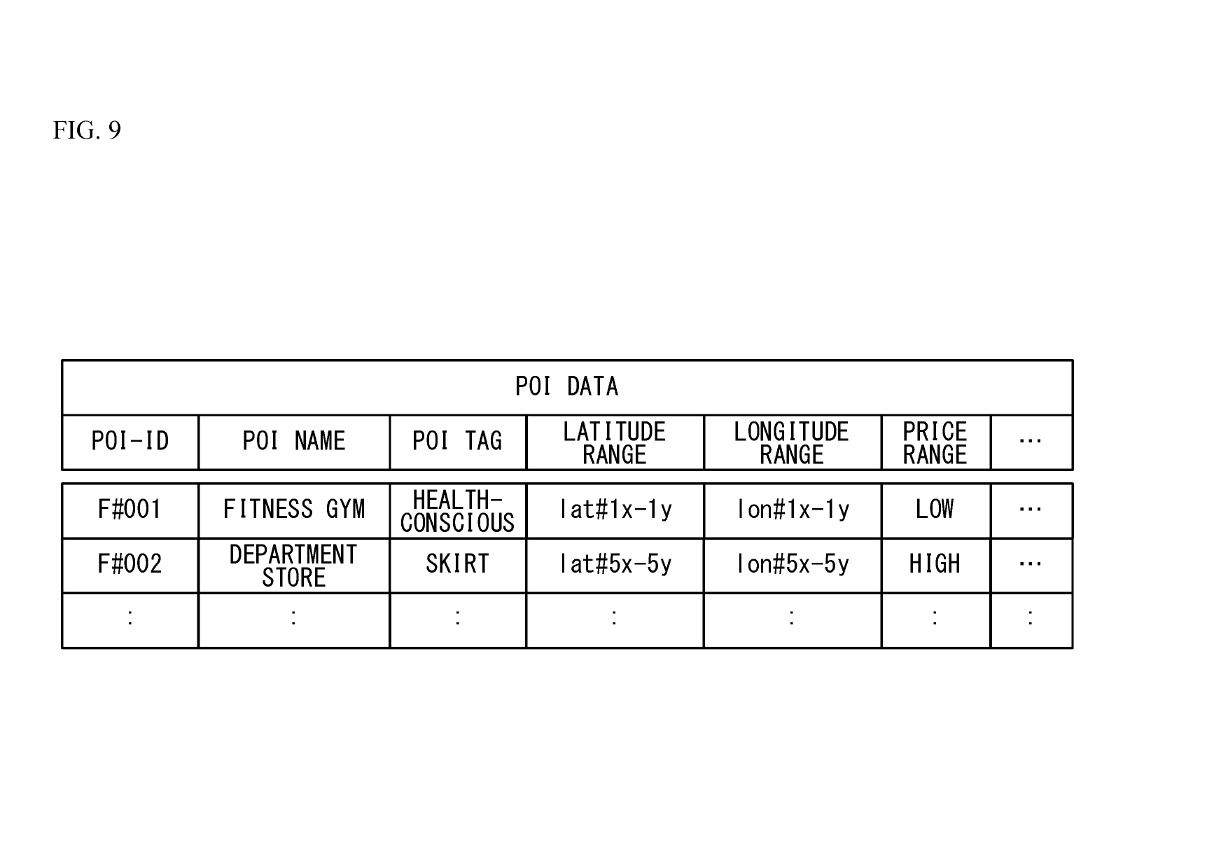

Returning to FIG. 3, the POI information storage unit 116 stores the POI data related to the above-described POI. As illustrated in FIG. 9, the POI data includes a plurality of items such as a POI-ID, a POI name, a POI tag, a latitude range, a longitude range, and a price range. In the item of the POI-ID, a unique identifier for identifying the POI is registered. A name of the POI is registered in the item of the POI name. In the item of the POI tag, a characteristic of the POI is registered.

In the item of the latitude range, a range of the latitude in which the POI is located is registered. In the item of the longitude range, a range of the longitude in which the POI is located is registered. An occupied area of the POI on the map information is uniquely specified by the latitude range and the longitude range registered in the items of the latitude range and the longitude range. Therefore, when the latitude and longitude included in the human flow data are included in the occupied area of the POI, it is estimated that the actual purchaser or the non-purchaser located at the latitude and longitude has visited the POI. In the item of the price range, a price range of the old product or the new product handled at the POI is registered.

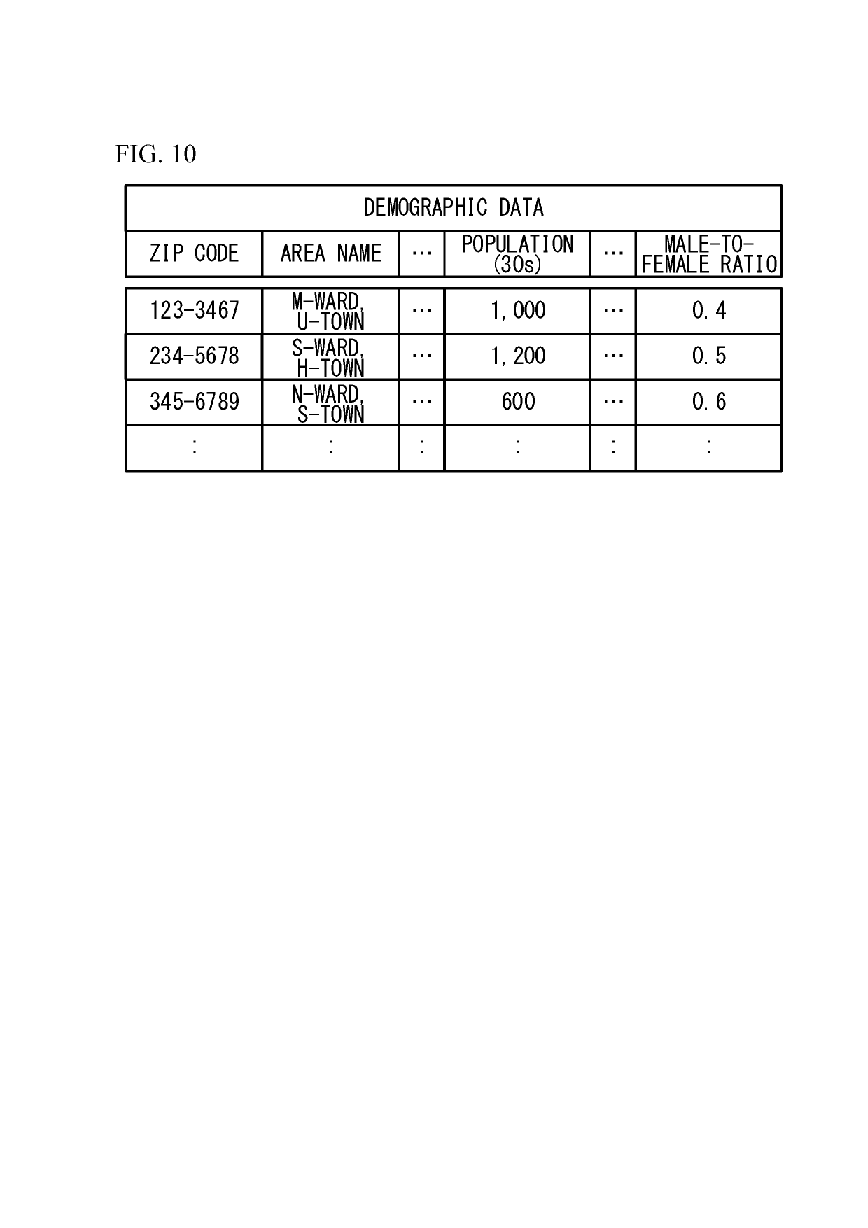

Referring back to FIG. 3, the demographic storage 117 stores demographic data representing the statistics of the population in the designated area. As illustrated in FIG. 10, the demographic data includes a plurality of items such as a zip code, an area name, an age-based population, and a male-to-female ratio. In the item of the zip code, a zip code that specifies the designated area is registered. In the item of the area name, an area name (for example, a municipality name) of the designated area is registered. Instead of the item of the area name, an item of a station name may be adopted. In this case, a station name of the designated station is registered in the item of the station name. In the item of the age-based population, an age-based population in the designated area is registered. In FIG. 10, a population in the 30s is illustrated as an example, and population in other ages is omitted. In the item of the male-to-female ratio, a male-to-female ratio in the designated area is registered. The age-based population and the male-to-female ratio in the designated area may be obtained by using information provided by a municipality that manages the designated area.

Returning to FIG. 3, the training data generation unit 121 acquires the human flow data (see FIG. 4) of the actual purchaser in the designated area from the human flow storage unit 111. The training data generation unit 121 acquires the ID-POS data (see FIG. 8) from the purchase history storage unit 115. When the human flow data of the actual purchaser and the ID-POS data are acquired, the training data generation unit 121 generates a plurality of pieces of training data each defining the relationship between the human flow data of the actual purchaser and the ID-POS data.

For example, the training data generation unit 121 generates the plurality of pieces of training data based on the identifiers of the actual purchaser included in common in the human flow data of the actual purchaser and the ID-POS data. The training data generation unit 121 may generate the plurality of pieces of training data based on the identifiers of the advertisements included in common in the human flow data of the actual purchaser and the ID-POS data. In this way, the training data generation unit 121 can generate a plurality of pieces of training data each defining the relationship between the human flow data of the actual purchaser and the ID-POS data.

The model generation unit 122 generates a learned model by performing machine learning on the plurality of pieces of training data generated by the training data generation unit 121. Here, there is a high possibility that there is a correlation between the human flow of the actual purchaser and the purchase of the old product by the actual purchaser. Therefore, the model generation unit 122 adjusts and calculates coefficients satisfying the correlation. Accordingly, the model generation unit 122 can estimate the correlation between the human flow of the actual purchaser and the purchase of the old product by the actual purchaser.

The potential estimation unit 123 acquires the human flow data of the non-purchaser in the designated area from the human flow storage unit 111. When the potential estimation unit 123 acquires the human flow data of the non-purchaser, the potential estimation unit 123 estimates the purchase possibility of the non-purchaser with respect to the new product based on the human flow data of the non-purchaser and the learned model generated by the model generation unit 122. Specifically, the potential estimation unit 123 acquires the purchaser attribute data (see FIG. 6) from the purchaser attribute storage unit 113, and estimates the level of the purchase possibility of the non-purchaser having an attribute common to the attribute of the actual purchaser.

The potential estimation unit 123 may specify a part of the identifiers of the advertisements based on the level of the purchase possibility, and use the specified part of the identifiers of the advertisements for the human flow data of the non-purchaser. Accordingly, for example, the potential estimation unit 123 can appropriately distribute the advertisement of the new product to the non-purchaser having a high purchase possibility. As a result, the willingness of the non-purchaser to purchase the new product is aroused. The level of the purchase possibility may be a degree of the purchase possibility such as high and low of the purchase possibility, or may be a numerical value such as a purchase probability.

The potential estimation unit 123 may estimate the number of purchases of the actual purchaser and a purchase frequency of the actual purchaser based on the ID-POS data. Therefore, the potential estimation unit 123 can estimate the purchase tendency of the non-purchaser defined by various purchase factors such as a frugal person or a spendthrift, for example, based on any one of the estimated number of purchases of the actual purchaser and the estimated purchase frequency of the actual purchaser. The purchase factor is not particularly limited to the frugal person or the spendthrift. Various terms representing the purchase habit may be used as the purchase factor.

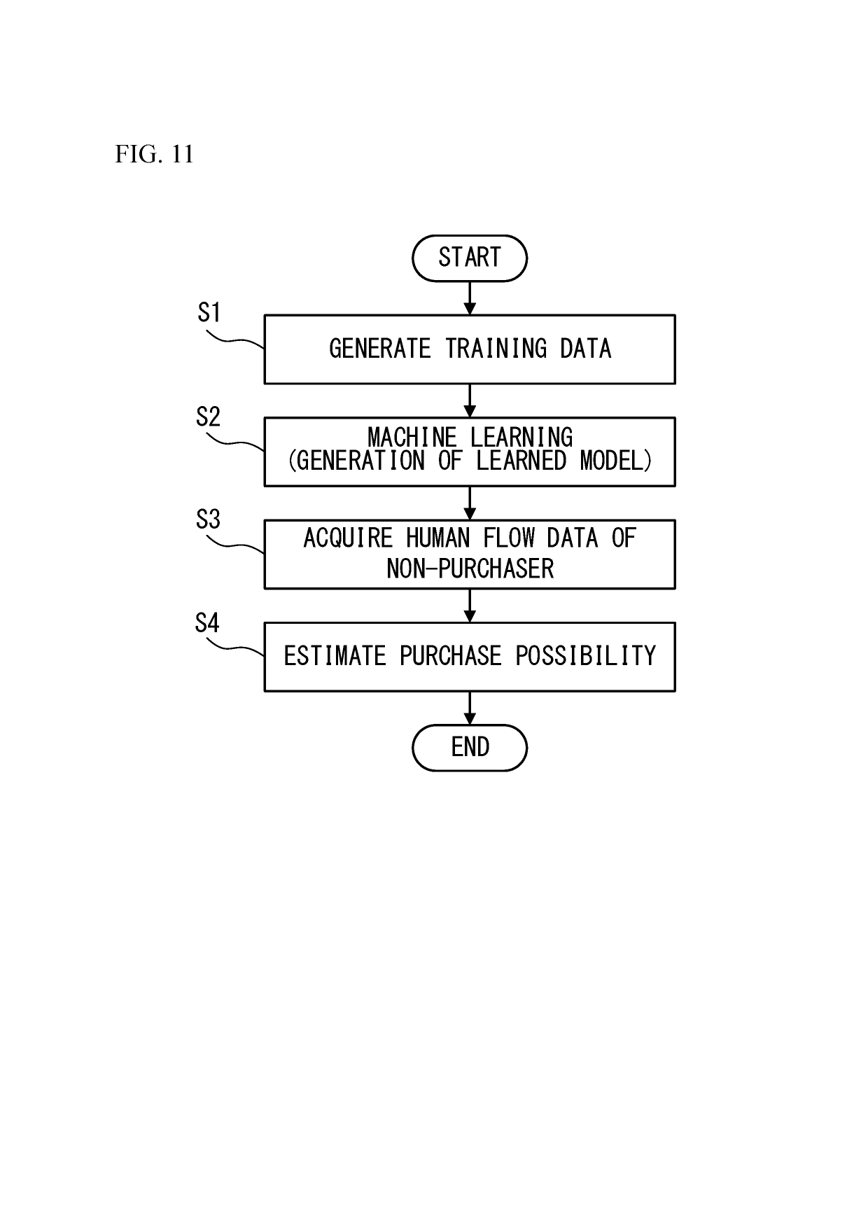

The operation of the data processing server 100 will be described with reference to FIG. 11.

First, the training data generation unit 121 generates the training data (step S1). For example, when the training data generation unit 121 receives an instruction corresponding to a predetermined operation, the training data generation unit 121 acquires the human flow data of the actual purchaser and the ID-POS data, and generates a plurality of training data each defining the relationship between the human flow data of the actual purchaser and the ID-POS data.

When the training data generation unit 121 generates the training data, the model generation unit 122 generates a learned model by machine learning (step S2). As described above, the model generation unit 122 generates the learned model by performing machine learning on the plurality of pieces of training data. When the model generation unit 122 generates the learned model, the potential estimation unit 123 then acquires the human flow data of the non-purchaser from the human flow storage unit 111 (step S3).

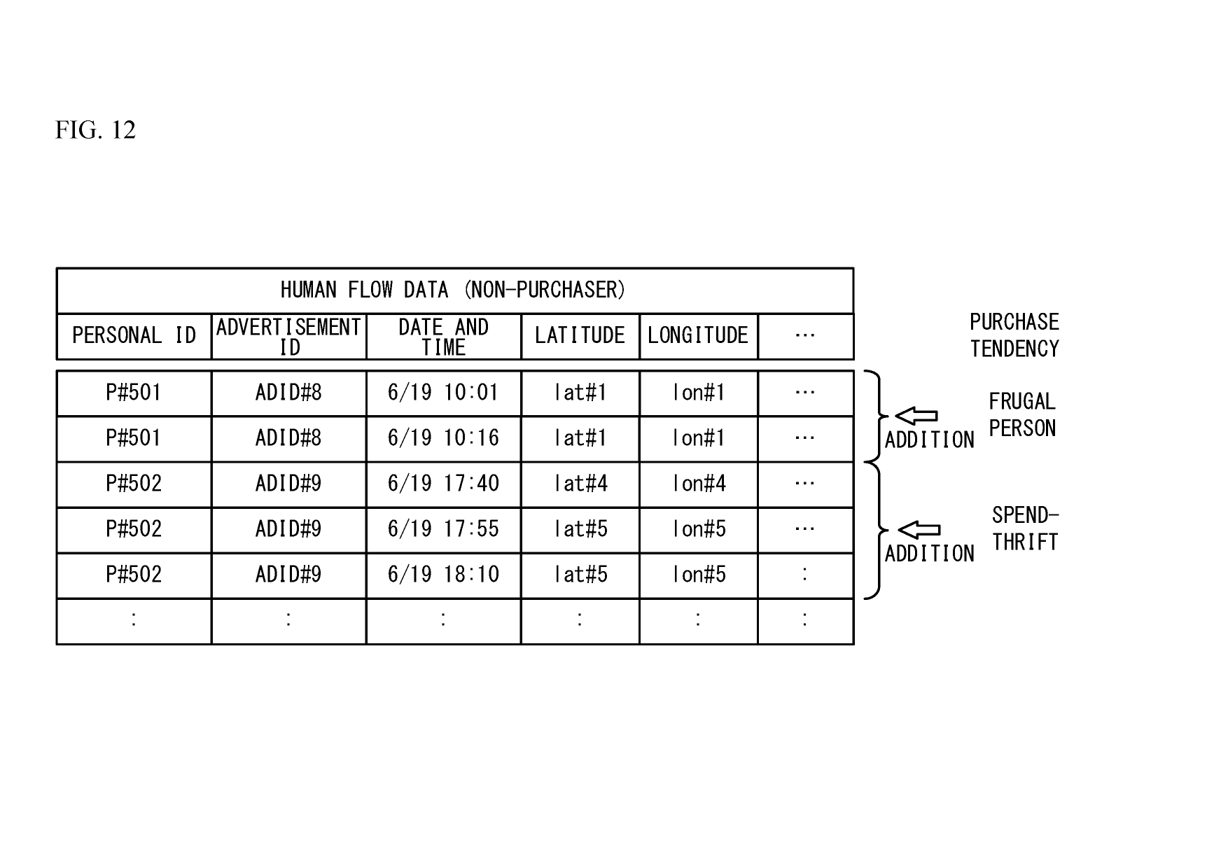

When the human flow data of the non-purchaser is acquired, the potential estimation unit 123 estimates the purchase possibility of the non-purchaser with respect to the new product based on the human flow data of the non-purchaser and the learned model (step S4). For example, as illustrated in FIG. 12, the potential estimation unit 123 can assign a purchase tendency of the non-purchaser such as a frugal person or a spendthrift to the human flow data of the non-purchaser identified by an identifier different from the identifier of the actual purchaser individual. When the potential estimation unit 123 estimates the purchase possibility of the non-purchaser, a potential estimation unit 102 ends the process.

As described above, according to the first embodiment, the data processing server 100 can generate the learned model by performing machine learning on the plurality of pieces of training data each defining the relationship between the human flow data of the actual purchaser and the ID-POS data. In addition, when the learned model is generated, the data processing server 100 can estimate the purchase possibility of the non-purchaser with respect to the new product based on the human flow data of the non-purchaser and the learned model. By using the data processing server 100, the user 11 can understand the purchase possibility of the new product, and can develop the new product effective for the market without waste.

### Second Embodiment

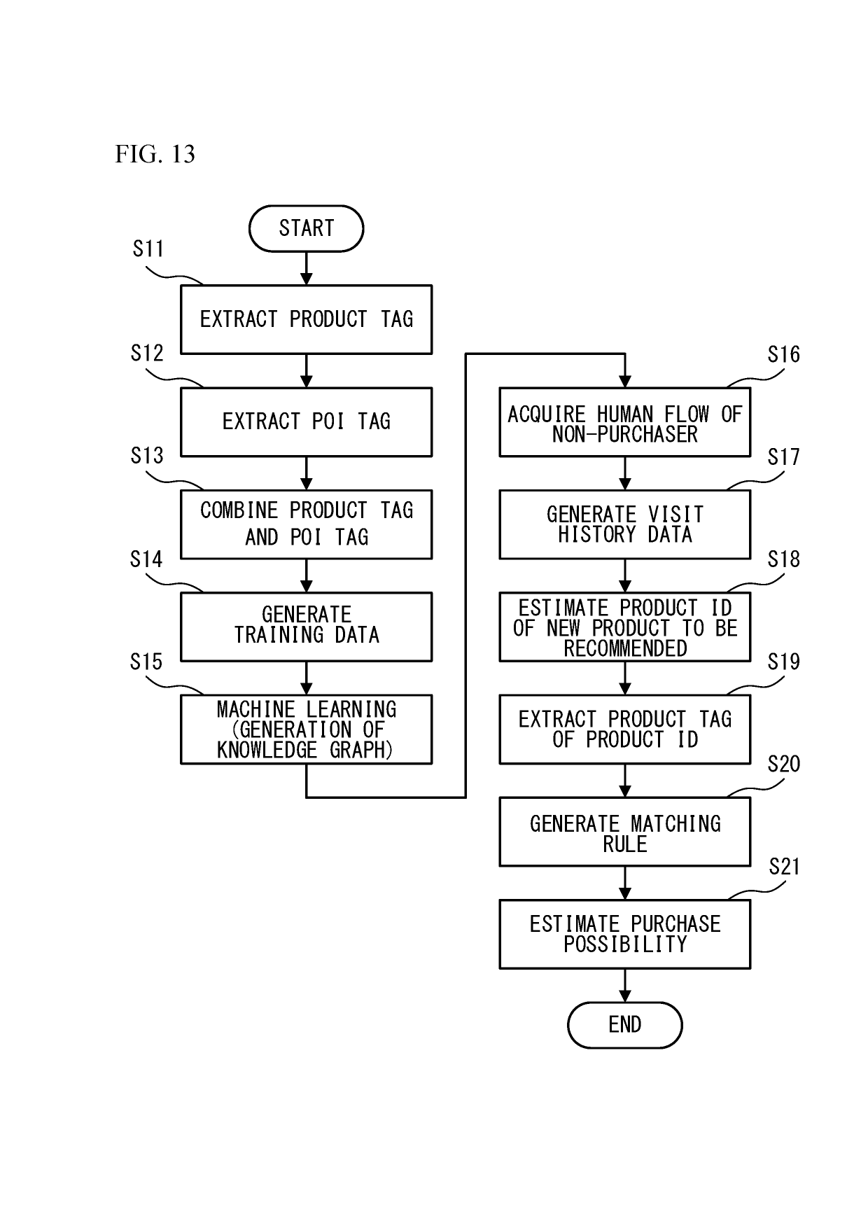

A second embodiment of the present disclosure will be described with reference to FIGS. 13 to 15. In the first embodiment, the estimation of the level of the purchase possibility of the non-purchaser and the purchase tendency of the non-purchaser defined by various purchase factors such as the frugal person or the spendthrift has been described. In the second embodiment, a description will be given of estimation of the number of non-purchaser who are likely to purchase the new product in the designated area, a purchase probability that the non-purchaser purchases the new product, a planned purchase quantity of the new product in the designated area, and the like.

First, as illustrated in FIG. 13, the training data generation unit 121 extracts a product tag (step S11). More specifically, first, the training data generation unit 121 acquires the ID-POS data (see FIG. 8) from the purchase history storage unit 115, and extracts the identifier of the old product registered in the ID-POS data together with the identifier of the actual purchaser individual. When the identifier of the old product is extracted, the training data generation unit 121 acquires the product data (see FIG. 7) from the product information storage unit 114, and extracts the product characteristic of the old product associated with the identifier of the old product as the product tag.

Here, the product tags may be defined by different words. However, even if the product tags are defined by different words, the product tags may have a common concept or meaning. Therefore, the training data generation unit 121 attempts to unify the product tags having a common concept based on, for example, large language models (LLM). For example, the training data generation unit 121 specifies any one of the product tags having the common concept as a representative product tag. This reduces the quantity of product tags and improves the processing speed of subsequent processing.

When the product tag is extracted, the training data generation unit 121 extracts the POI tag (step S12). More specifically, first, the training data generation unit 121 acquires the visit history data (see FIG. 5) generated based on the human flow data of the actual purchaser from the visit history storage unit 112, and extracts the POI tag registered in the visit history data together with the identifier of the actual purchaser individual.

Even if the POI tags are defined by different words, they may have a common concept or meaning. Therefore, the training data generation unit 121 unifies the POI tags having the common concept based on the LLM, and specifies the representative POI tag. This reduces the quantity of POI tags and improves the processing speed of subsequent processing. The POI tag is an example of a facility tag.

When the POI tag is extracted, the training data generation unit 121 combines the product tag and the POI tag (step S13). For example, the training data generation unit 121 combines the product tag and the POI tag based on a predetermined rule defined in advance, such as cross domain recommendation (CDR). For example, the training data generation unit 121 can combine the product tag and the POI tag based on the redundancy (overlap degree) of the words included in both of the product tag and the POI tag. The training data generation unit 121 may find the redundancy of words based on the LLM and may combine the product tag and the POI tag.

When the product tag and the POI tag are combined, the training data generation unit 121 generates training data (step S14). More specifically, the training data generation unit 121 generates the plurality of pieces of training data each defining the relationship between the tag data obtained by combining the product tag and the POI tag, and combination data obtained by combining the identifier of the actual purchaser individual and the identifier of the old product. Accordingly, the actual purchaser individual having both a product domain representing the domain of the old product and a POI domain representing the domain of the POI is associated, and the purchase preference of the actual purchaser individual is specified.

After generating the training data, the model generation unit 122 generates a knowledge graph of the POI by performing machine learning on the training data (step S15). By using the knowledge graph as such a learned model, the product domain is inferred from the POI domain.

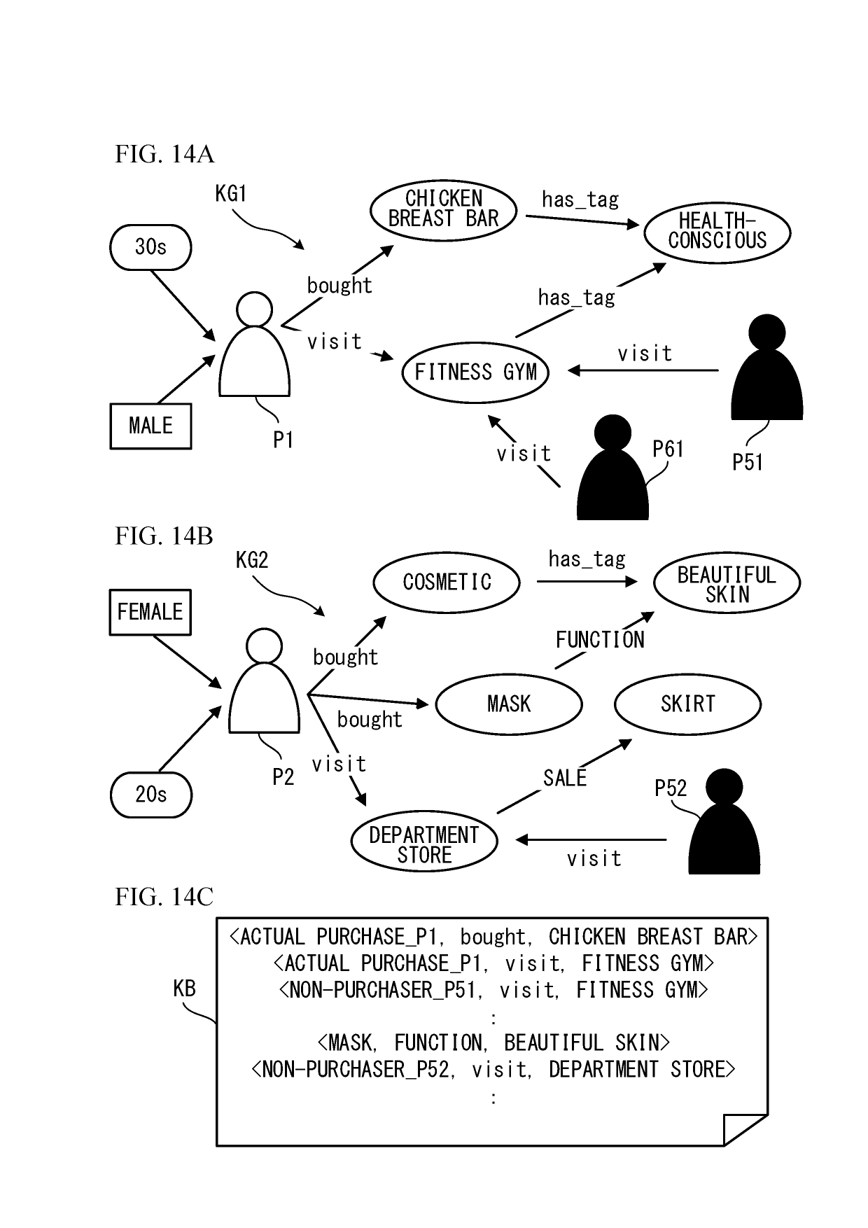

For example, according to the ID-POS date (see FIG. 8) and the product date (see FIG. 7), an actual purchaser P1 identified by a purchaser ID “P#001” purchased an old product “chicken breast bar”. Further, according to the visit history (see FIG. 5), the actual purchaser P1 identified by a personal ID “P#001” visited a POI “fitness gym”. Here, the old product “chicken breast bar” is associated with a product tag “health-conscious”. The POI tag “health-conscious” is associated with the POI “fitness gym”. As a result, when the model generation unit 122 generates the knowledge graph, a first knowledge graph KG1 related to the actual purchaser P1 is generated as illustrated in FIG. 14A.

Similarly, according to the ID-POS date (see FIG. 8) and the product date (see FIG. 7), an actual purchaser P2 identified by a purchaser ID “P#002” purchased an old product “cosmetic”. Further, according to the visit history (see FIG. 5), the actual purchaser P2 identified by a personal ID “P#002” visited a POI “department store”. Here, the old product “cosmetic” is associated with the product tag “beautiful skin”. Further, a POI tag “skirt” is associated with the POI “department store”. Therefore, when the model generation unit 122 generates the knowledge graph, a second knowledge graph KG2 related to the actual purchaser P2, which is different from the first knowledge graph KG1, is generated as illustrated in FIG. 14B.

In addition, if a non-purchaser P51 identified by a personal ID “P#501” has visited the POI “fitness gym” based on the visit history data, the POI “fitness gym” of the non-purchaser P51 is associated with the first knowledge graph KG1, as illustrated in FIG. 14A. The same applies to a non-purchaser P61. If a non-purchaser P52 identified by a personal ID “P#502” has visited the POI “department store” based on the visit history data, the POI “department store” of the non-purchaser P52 is associated with the second knowledge graph KG2 as illustrated in FIG. 14B.

When the model generation unit 122 generates various knowledge graphs such as the first knowledge graph KG1 and the second knowledge graph KG2, the model generation unit 122 embeds nodes and edges in the knowledge graphs into a three dimensional vector space. As an embedding method, for example, TransE is known. Here, in the knowledge graph, the expression of knowledge is expressed in a form called a triple such as “the value (object) of r (predicate) is o for s (subject)”. The subject (s) and object (o) are called entities, and the predicate (r) is called a relation. The entity corresponds to the node, and the relation corresponds to the edge. For example, in the present embodiment, the actual purchaser P1and P2, the POI “fitness gym”, and the POI “department store” correspond to the entities (or nodes). The relationship between entities such as purchase and visit corresponds to the relation.

The triple is symbolically represented as [s, r, o], and the three elements of the triple are represented by three vectors in the embedding space, respectively. Embedding is to express the knowledge as triple data and the entities and relations as vectors. By embedding the nodes and edges in the knowledge graph into the three dimensional vector space, a knowledge graph aggregate KB storing the three term relationships (triplets) in the knowledge graph is generated as illustrated in FIG. 14C. Such embedding allows the estimate of unknown triples.

Referring back to FIG. 13, after the model generation unit 122 generates the knowledge graph, the potential estimation unit 123 acquires the human flow of the non-purchaser (step S16), and generates the visit history of the non-purchaser (step S17). More specifically, the potential estimation unit 123 acquires the human flow data of the non-purchaser from the human flow storage unit 111 and acquires the POI data from the POI information storage unit 116. When the human flow data of the non-purchaser and the POI data are acquired, the potential estimation unit 123 generates the visit history data of the non-purchaser with respect to the POI based on time period data indicating a time period during which the non-purchaser stays at the POI, the latitude and longitude registered in the human flow data, and the latitude range and longitude range registered in the POI data.

When the visit history of the non-purchaser is generated, the potential estimation unit 123 estimates the product ID of the new product to be recommended (step S18). More specifically, the potential estimation unit 123 estimates the product ID of the new product to be recommended to the non-purchaser P51, P52, and P61 based on the visit history of the non-purchaser, the knowledge graph aggregate KB, and a known KGAT (Knowledge Graph Attention Network) model. The KGAT may output the purchase probabilities of the new product of the non-purchaser P51, P52, and P61. The KGAT model can be referred to the following Non-Patent Literature 1.

### Non-Patent Literature 1

Fumiyo Ito, et al., “A study on Analysis Model of Customers' Purchasing Behavior based on Knowledge Graph Attention Network”, Journal of the Information Processing Society of Japan, Vol. 63, No. 1, pp. 205 to 217, 2022-01

When the product ID is estimated, the potential estimation unit 123 extracts the product tag of the product ID (step S19). For example, the potential estimation unit 123 accesses the product information storage unit 114 and extracts the product tag corresponding to the estimated product ID for each product ID. The potential estimation unit 123 may extract a single product tag or a plurality of product tags in units of product IDs. After extracting the product tags, the potential estimation unit 123 complements the knowledge graph aggregate KB based on the extracted product tags and the KGAT model.

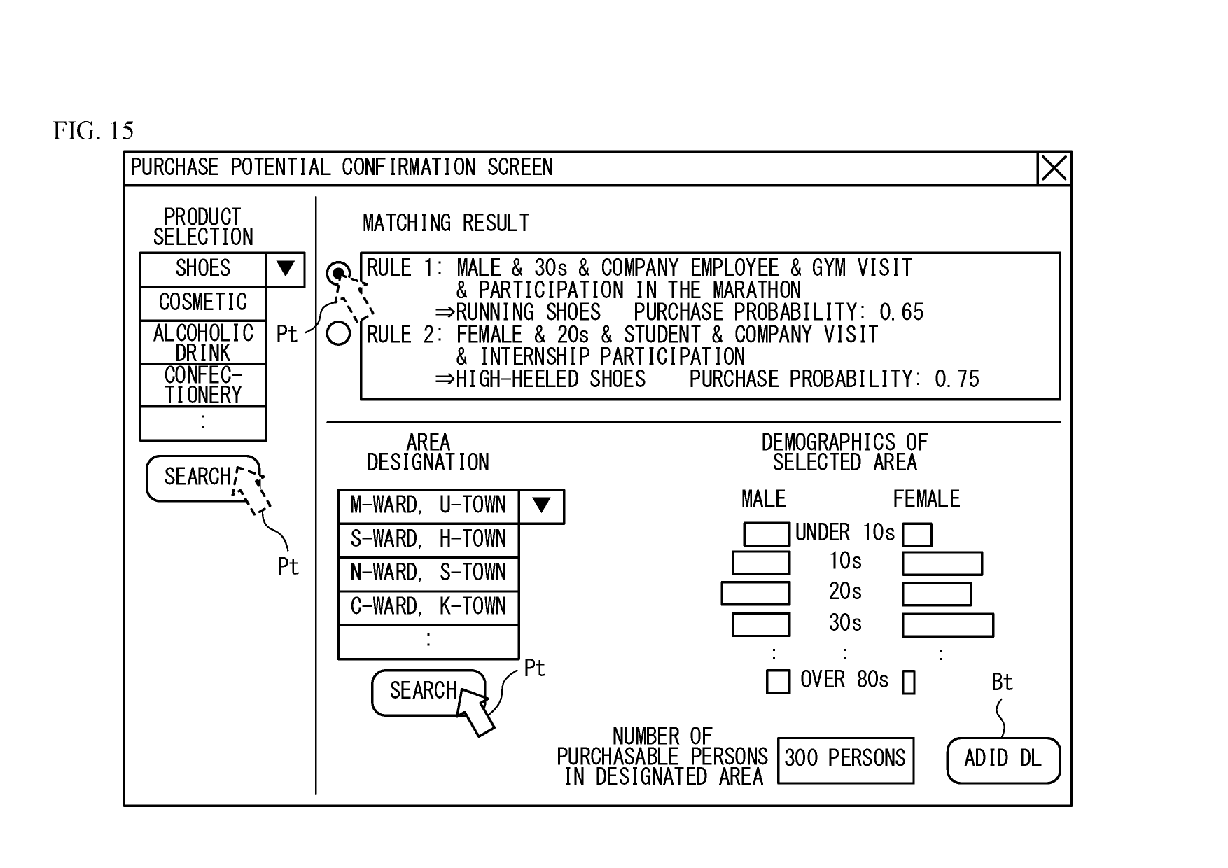

Here, when the potential estimation unit 123 detects input or selection of a confirmation item related to the advertisement of the product based on the operation of the user 11, the potential estimation unit 123 generates a matching rule (step S20). For example, as illustrated in FIG. 15, when any one of the products is selected and the search is instructed by a pointer Pt on a purchase potential confirmation screen displayed on the display device 14, the terminal device 10 transmits the confirmation item related to the advertisement of the selected product to the potential estimation unit 123. The purchase potential confirmation screen is an example of a predetermined screen. The confirmation item is not limited to the selection of the product, and may be, for example, selection or input of a brand name, a JAN code, or the like of the product, or selection or input of an event name or an event venue of various events. The confirmation item may be selection or input of the age or gender of the advertisement distribution target person, selection or input of the facility name of a facility including a store that sells a product, selection or input of the name of a region or an area, or the like.

When the potential estimation unit 123 receives the confirmation item, the potential estimation unit 130 detects the selection of the confirmation item, and extracts the attribute of the non-purchaser from the purchaser attribute storage unit 113 based on the identifier of the non-purchaser individual registered in the human flow data of the non-purchaser not associated with the ID-POS data. When the potential estimation unit 123 extracts the attribute of the non-purchaser, the potential estimation unit 120 associates the attribute of the non-purchaser, the extracted product tags, the product names corresponding to the confirmation item, and the like, with the purchase probabilities of the new products output by the KGAT, narrows down the weights of the edges in the knowledge graph by threshold values, and then adds the edges narrowed down to all the users and the purchasable products to the original knowledge graph. When the potential estimation unit 123 adds the edges to the original knowledge graph, a potential estimation unit 104 generates a matching rule based on an Apriori algorithm and a Bayesian network, and outputs the matching rule to the purchase potential confirmation screen. The weights of the edges represent the importance of the relevance between the user and the products (for example, see FIG. 3 of Non-Patent Literature 1), and the threshold values are set in advance. All the users include a user who has the visit history data but does not have the ID-POS data and a user who has both the visit history data and the ID-POS data.

As a result, as illustrated in FIG. 15, the matching rule appears on the purchase potential confirmation screen as a matching result. For example, the user 11 can understand a specific product name and a purchase probability of the non-purchaser for the product having the product name with respect to a combination of a product tag indicating an attribute of the non-purchaser for a product “shoes” and a characteristic of the product. For example, if an event name is input as the confirmation item, a combination of a plurality of items related to the event name appears on the purchase potential confirmation screen as the matching rule. The potential estimation unit 123 may output one optimal matching rule or a plurality of matching rules having a high advertising effect as the matching result. The user 11 can understand the various matching rules and use the matching rules themselves to consider how to deliver the advertisement.

When the matching rule is generated, the potential estimation unit 123 then estimates the purchase possibility (step S21). For example, as illustrated in FIG. 15, when any matching result is selected by the pointer Pt on the purchase potential confirmation screen displayed on the display device 14, the terminal device 10 transmits a display instruction of the area designation to the potential estimation unit 123.

When the potential estimation unit 123 receives the display instruction, the potential estimation unit 123 outputs an area designation field for designating any one of a plurality of areas to the purchase potential confirmation screen as illustrated in FIG. 15. When any one of the areas is designated by the pointer Pt and the search is instructed by the pointer Pt on the purchase potential confirmation screen, the terminal device 10 transmits an instruction to calculate the number of purchasable persons in the designated section to the potential estimation unit 123.

When receiving the calculation instruction, the potential estimation unit 123 accesses the demographic storage unit 117, and calculates the number of purchase target persons obtained by multiplying the population of the age group corresponding to the designated area by the male-to-female ratio based on the gender, the age group, and the designated area included in the selected matching result. When the number of purchase target persons is calculated, the potential estimation unit 123 calculates the number of purchasable persons in the designated area by multiplying the purchase probability included in the matching result by the number of purchase target persons. When the potential estimation unit 123 calculates the number of purchasable persons, the potential estimation unit 130 outputs the number of purchasable persons to the purchase potential confirmation screen.

As a result, as illustrated in FIG. 15, the number of purchasable persons in the designated area appears on the purchase potential confirmation screen as the purchase possibility. The potential estimation unit 123 may calculate and output the purchasable quantity, the purchasable amount, or the like by multiplying the number of purchasable persons by a predetermined coefficient. Accordingly, the user 11 can understand the number of purchasable persons, the purchasable quantity, the purchasable amount, and the like in the designated area.

Further, by preparing in advance a past sales history of a product belonging to the same category as the selected product, the potential estimation unit 123 may calculate a future sales forecast of the selected product in the designated period based on the number of purchasable persons, the sales history, and a known method. The potential estimation unit 123 outputs the future sales forecast to the purchase potential confirmation screen, and thus the user 11 can understand the future sales of the selected product. As the known method, for example, the following Non-Patent Literature 2 can be referred to.

### Non-Patent Literature 2

Kenji Tanaka, “A sales forecasting model for new-released and nonlinear sales trend products”, Expert Systems with Applications, Vol. 37, Issue. 11, pp. 7387-7393, Nov 2010

In addition, the potential estimation unit 123 may output the processing result to a screen different from the purchase potential confirmation screen. When the potential estimation unit 123 detects that the advertisement ID download button Bt provided on the purchase potential confirmation screen is pressed by the pointer Pt, the potential estimation unit 123 may generate a list of advertisement IDs of advertisement distribution target persons corresponding to the number of purchasable persons and download the list to the terminal device 10. This enables pinpoint distribution of the advertisement to a mobile terminal having the advertisement ID.

As described above, according to the second embodiment, the data processing server 100 combines the product tag of the old product extracted based on the ID-POS data, and the POI tag extracted based on the human flow data and the visit history data of the actual purchaser, based on a common attribute of their tags. The data processing server 100 generates combination data of the purchaser ID of the actual purchaser and the product ID of the old product. Then, the data processing server 100 can generate the knowledge graph aggregate KB by performing the machine learning on the plurality of pieces of training data each defining the relationship between the tag data obtained by combining the product tag and the POI tag, and the combination data.

When the knowledge graph aggregate KB is generated, the data processing server 100 generates visit history data of the non-purchaser with respect to the POI based on the human flow data of the non-purchaser in the designated area and the time period data of the non-purchaser staying at the POI included in the designated area. Then, the data processing server 100 can estimate the product ID of the new product recommended to the non-purchaser based on the visit history data and the knowledge graph aggregate KB, and estimate the purchase possibility of the advertisement distribution target person based on the product tag of the new product identified by the product ID and the attribute of the non-purchaser. By using the purchase possibility of the advertisement distribution target person through the data processing server 100, the user 11 can understand the number of persons who have not yet purchased the new product, the quantity of purchases, the amount of purchase, and the like, and can develop the new product effective for the market without waste. Further, the user 11 can utilize the purchase possibility of the advertisement distribution target person for sales promotion activities of the entire products including the old product and the new product.

Although the embodiments of the present disclosure have been described in detail above, the present disclosure is not limited to the specific embodiments, and various change, substitutions, and alterations could be made hereto without departing from the spirit and scope of the disclosure. For example, the present case may be used in a case where a service for providing western food is developed as a new service in the market in a state where a service for providing Japanese food is already developed as an old service in the market in a restaurant.

What is claimed is:

1. A data processing method for causing a computer to execute a process, the process comprising:
acquiring first human flow data representing a human flow in a designated area of a non-purchaser with respect to an advertisement target; and
estimating a purchase possibility of an advertisement distribution target person for the advertisement target based on the first human flow data and a learned model;
wherein the learned model is generated by performing machine learning on a plurality of pieces of training data each defining a relationship between purchase data of an actual purchaser with respect to the advertisement target and second human flow data representing a human flow of the actual purchaser in the designated area.

2. The data processing method according to claim 1,
wherein each of the first human flow data, the second human flow data, and the purchase data includes a unique advertisement identifier stored in each of a plurality of mobile terminals, and
the process includes identifying a part of the advertisement identifier based on a level of the purchase possibility, and using an identified part of the advertisement identifier for the first human flow data.

3. The data processing method according to claim 1,
wherein the purchase data includes an attribute of the actual purchaser, and
the process includes estimating the purchase possibility of the advertisement distribution target person having an attribute common to the attribute of the actual purchaser.

4. The data processing method according to claim 1,
wherein the purchase data includes any one of a number of purchases and a purchase frequency of the actual purchaser, and
the process includes estimating a purchase tendency of the advertisement distribution target person based on any one of the number of purchases and the purchase frequency.

5. A data processing method for causing a computer to execute a process, the process comprising:
acquiring first human flow data representing a human flow in a designated area of a non-purchaser with respect to an advertisement target;
generating visit history data of the non-purchaser with respect to a specific facility included in the designated area based on the first human flow data and time period data representing a time period during which the non-purchaser stays in the specific facility;
estimating an advertisement target identifier of the advertisement target to be recommended to the non-purchaser based on the visit history data of the non-purchaser and a learned model; and
estimating a purchase possibility of an advertisement distribution target person for the advertisement target based on an advertisement target tag representing a characteristic of the advertisement target identified by an advertisement target identifier of the advertisement target, and an attribute of the non-purchaser;
wherein the learned model is generated by performing machine learning on a plurality of pieces of training data each defining a relationship between tag data, and combination data of a purchaser identifier of an actual purchaser and an advertisement target identifier of the advertisement target, the tag data being obtained by combining, based on a common attribute, an advertisement target tag representing a characteristic of the advertisement target extracted based on purchase data of the actual purchaser for the advertisement target and a facility tag representing a characteristic of the specific facility extracted based on visit history data of the actual purchaser for the specific facility, the visit history data being generated based on second human flow data representing a human flow of the actual purchaser in the designated area and time period data representing a time period during which the actual purchaser stays in the specific facility.

6. The data processing method according to claim 5,
wherein each of the first human flow data, the second human flow data, and the purchase data includes a unique advertisement identifier stored in each of a plurality of mobile terminals, and
the process includes identifying a part of the advertisement identifier based on a level of the purchase possibility, and using an identified part of the advertisement identifier for the first human flow data.

7. The data processing method according to claim 5,
wherein when input or selection of a confirmation item related to an advertisement of the advertisement target is detected through a predetermined screen, the process searches for an attribute of the non-purchaser corresponding to the confirmation item, and outputs a search result including a combination of attributes of the non-purchaser, and a purchase probability that the advertisement target is purchased by the non-purchaser to the predetermined screen or another screen different from the predetermined screen as a purchase possibility of the non-purchaser.

8. The data processing method according to claim 7,
wherein the process includes acquiring demographic data in the designated area, and calculating a sales quantity of the advertisement target in the designated area based on the demographic data and the purchase probability.

9. The data processing method according to claim 8,
wherein the process includes acquiring unit price data indicating a unit price of the advertisement object, and calculating a total purchase amount of the advertisement object by the non-purchaser in the designated area based on the sales quantity and the unit price data.

10. A data processing apparatus comprising:
a memory; and
a processor coupled to the memory and the processor configured to:
acquire first human flow data representing a human flow in a designated area of a non-purchaser with respect to an advertisement target; and
estimate a purchase possibility of an advertisement distribution target person for the advertisement target based on the first human flow data and a learned model;
wherein the learned model is generated by performing machine learning on a plurality of pieces of training data each defining a relationship between purchase data of an actual purchaser with respect to the advertisement target and second human flow data representing a human flow of the actual purchaser in the designated area.

11. A data processing apparatus comprising:
a memory; and
a processor coupled to the memory and the processor configured to:
acquire first human flow data representing a human flow in a designated area of a non-purchaser with respect to an advertisement target;
generate visit history data of the non-purchaser with respect to a specific facility included in the designated area based on the first human flow data and time period data representing a time period during which the non-purchaser stays in the specific facility;
estimate an advertisement target identifier of the advertisement target to be recommended to the non-purchaser based on the visit history data of the non-purchaser and a learned model; and
estimate a purchase possibility of an advertisement distribution target person for the advertisement target based on an advertisement target tag representing a characteristic of the advertisement target identified by an advertisement target identifier of the advertisement target, and an attribute of the non-purchaser;
wherein the learned model is generated by performing machine learning on a plurality of pieces of training data each defining a relationship between tag data, and combination data of a purchaser identifier of an actual purchaser and an advertisement target identifier of the advertisement target, the tag data being obtained by combining, based on a common attribute, an advertisement target tag representing a characteristic of the advertisement target extracted based on purchase data of the actual purchaser for the advertisement target and a facility tag representing a characteristic of the specific facility extracted based on visit history data of the actual purchaser for the specific facility, the visit history data being generated based on second human flow data representing a human flow of the actual purchaser in the designated area and time period data representing a time period during which the actual purchaser stays in the specific facility.
